(19) United States
(12) Patent Application Publication
(10) Pub. No.: US 2017/0085937 A1
(43) Pub. Date: Mar. 23, 2017

(54) Managing DVR Recordings during Changes in Schedule

(71) Applicant: Samuel H. Russ, Mobile, AL (US)

(72) Inventor: Samuel H. Russ, Mobile, AL (US)

(21) Appl. No.: 14/862,135

(22) Filed: Sep. 22, 2015

(51) Int. Cl. H04N 21/262; H04N 21/488; H04N 21/482; H04N 21/472; H04N 21/4147; H04N 21/433

(52) U.S. Cl. CPC H04N 21/26291; H04N 21/4147; H04N 21/4334; H04N 21/4821; H04N 21/47214; H04N 21/4882; H04N 21/4884

(57) ABSTRACT

A system and method for managing the digital video recorder (DVR) recording process during unplanned changes in schedule is described. In one embodiment, for example, codes that indicate the current condition of the television program are broadcast with the program. The codes are used to indicate common conditions such as television programs running longer than planned or programs being pre-empted. The codes enable the management of both current and subsequent programming, enable correcting the start and end times of recordings, and enable detection of program cancellation.

### BACKGROUND OF THE INVENTION

Digital Video Recording (DVR) has emerged as a popular method for recording, viewing, and managing video content in the home. DVR is usually embodied in a set-top box (STB) but could also be implemented in a home computer or similar device. Generally speaking, DVR units (or “DVRs”) use an electronic program guide (EPG) to schedule recordings. That is, the EPG provides the information necessary to show the schedule to the user, receive recording requests from the user, and manage the mechanics of starting and ending recording. (The EPG is also sometimes referred to as an interactive program guide or just a program guide.)

Often unscheduled changes in programming occur, such as when a football game runs beyond its allotted time. This has a ripple effect on the subsequent programming. DVRs often record programming at the wrong time because the programs themselves are running late. Worse yet, they tend to leave out the last few minutes of the programs themselves, including notably the sporting event, which is usually the most interesting, suspenseful, or important. There needs to be a consistent, easily embodied system for correcting DVR recording times.

Several systems have been proposed in the past to deal with these and similar circumstances.

U.S. Pat. No. 8,270,818 to Dolph discloses a system for managing subsequent recording of post-programming content. However, the transmission of the content is itself a pre-planned event, and the post-programming content is an adjunct to normal programming.

U.S. Pat. No. 8,428,436 to Howarter et al. discloses a system in which the DVR unit scans for an “end-of-program” code. If the code does not arrive, the unit can continue recording until a code is received. This system does not deal with subsequent programming being postponed or truncated, and it operates by postponing recording in the event a signal is not received. This can lead to erroneous results if the code is somehow missed or dropped.

U.S. Application 2010/0162305 to Downey et al. discloses a system in which DVR set-top boxes must first request content from a headend. The headend the subsequently notifies the individual STB of changes in schedule. This is a two-way system, requiring the STB to first issue a request to a headend, and it is a point-to-point system in the sense that the headend must notify each registered STB. A broadcast system not requiring headend notification is preferable because it scales and can potentially work across multiple service providers.

U.S. Application 2012/0272273 to Gramman et al. discloses a system in which the EPG data is updated in the event of a change. The STB then checks the EPG to see if the schedule has changed and, if so, modifies its recording times. This has at least three disadvantages. First, it is tied to a single proprietary program guide and so does not address the issue on a national scale. Second, it relies on continuous updates to the EPG, requiring separate receiver resources and a dedicated data pipeline for EPG data. Third, there is considerable latency from the broadcaster's decision to modify the schedule to detecting and updating the EPG to transmitting and receiving the updated EPG and to detecting the relevant changes in EPG data. It is unclear that the system can respond rapidly to last-minute changes in schedule.

What is needed, then, is a system that relies on broadcast messages (or specially formatted network traffic) that can be used by any DVR unit to process unplanned schedule changes. The system needs to work with multiple (or potentially all) service providers and local affiliates. It needs to be rapidly responsive to last-minute changes. And it needs to be simple so as not to impose a significant burden on the DVR.

### BRIEF SUMMARY OF THE INVENTION

The invention applies to any unit capable of performing digital video recording. Such a unit is often termed a digital video recorder (DVR) and can be embodied in a set-top box (STB), personal computer, smart phone or tablet, or any device capable of receiving and storing video. The DVR may even be a server at the headend that is directed to record video on behalf of subscribers; this system is called Network DVR. Some DVRs can receive analog video, convert it to digital, and then record in a digital format. Hence the term “digital” refers to the recorded content.

Television viewing can be broken down into broadcast content and on-demand content. Broadcast content arrives at the service provider's headend or the studio of a local affiliate of a national broadcast network. This content is usually identified with a specific broadcaster, which is often colloquially known as a “channel” (e.g. The Golf Channel) or a “network” (e.g. The Cable News Network). The terms channel and network are technically ambiguous, as modern digital video technology has enabled the carriage of multiple streams of television programming on a single allocated space of bandwidth. For the purposes of discussion, this specification will refer to a single broadcast stream, such as the Golf Channel, HBO, or ESPN, as a “channel.”

The specification will refer to the entity responsible for the management of a channel as a “broadcaster.” One corporation may own multiple channels, such as the Disney Corporation which owns ESPN, ABC, and the Disney Channel. For the purposes of the specification, this will be treated as multiple broadcasters because each channel is independently managed with respect to last-minute changes in schedule.

Each broadcaster usually provides an essentially unending stream of television broken down into individual shows, programs or events. These will be referred to as “shows,” “programs,” or “programming” in this specification.

Television can arrive in one's home several different ways. First, local broadcasters can transmit terrestrially over-the-air. Such broadcasters are often local affiliates for national networks such as ABC, and the transmissions are generally free to the viewer. Second, subscribers can pay for transmission of television programming, generally through coaxial cable, phone lines, dedicated fiber, or direct-broadcast satellite. This is collectively known as “pay TV.”

Generally speaking, DVRs use an electronic program guide (EPG) to track the schedule of upcoming programming. The EPG can be provided by pay TV service provider, which must gather and aggregate the data for all of its channels and programming, or can be bundled with the terrestrial over-the-air transmission. In either case, the EPG is usually transmitted as a separate, dedicated data channel that is electronically multiplexed with the programming.

Typically updates to the EPG are transmitted relatively infrequently (e.g. once per day or once every three hours). This is purposeful, as EPG data can consume a great deal of bandwidth. In addition, the process of creating EPG data can be convoluted, as it must pass from the broadcaster to the service provider or local affiliate, often via a third party that provides aggregation services. Thus there can be considerable latency from a change in schedule to a change in a DVR's EPG data.

Another, more serious problem with EPGs is that they are tied directly to the service provider or local affiliate. They are effectively proprietary data islands. A system that addresses changes in programming by posting changes to EPG data is not scalable across multiple service providers. So a broadcaster, such as ESPN, faces a daunting task if it attempts to notify DVRs of an unplanned, last-minute change in schedule.

This invention aims to solve this issue by either bundling the schedule changes with the programming itself, or by transmitting changes over an Internet connection (or similar data network). That is, by avoiding reliance on the EPG, a system can be developed which works across multiple service providers.

In one embodiment, the broadcaster's schedule changes are converted into a set of codes and other data that describe the current condition of the programming. These codes may indicate, for example, that the current program is running long, or that the current program has been postponed for 20 minutes and will be truncated early.

In one embodiment, these codes are bundled with the programming. At least one method for doing this is by embedding the codes in the closed-captioning stream that accompanies the programming. This has the advantages, first, of possible copyright protection, making the stream of codes less likely to be removed subsequently and, second, of carriage across the various reformatting steps that video often undergoes from the broadcaster to the home. (For example, a service provider may convert from a high-data-rate HD broadcast to a lower-data-rate SD broadcast by uncompressing the digital video and then recompressing it. Any programming metadata would be lost, except for the legal requirement to carry the closed-captioning data across the conversion process.)

The DVR can monitor the broadcaster's closed-captioning stream to check for schedule changes. Since closed-captioning streams are already processed by all video devices, as mandated by law, this does not necessitate any new capabilities on the DVR. Using the codes embedded in the stream, the DVR can monitor changes in the schedule in real-time. By using the same stream as the programming, there is very little chance of the information being dropped, and the information cannot be delayed.

In another embodiment, the codes are transmitted via the Internet or some other data network. For example, well-known services such as Twitter could be employed. The schedule updates would be received by the DVR, which would have to process the updates to determine their relevance.

### BRIEF DESCRIPTION OF THE SEVERAL VIEWS OF THE DRAWINGS

FIG. 1 is a typical system for broadcasting television programming and distributing it to DVRs in homes.

FIG. 2 is an example of a typical DVR unit.

FIG. 3 is an example of modifications that may be made to a television schedule.

FIG. 4 is an example of a set of codes and the data fields which can be employed to carry the information encoded in the codes.

FIG. 5 is an example of a method by which a DVR can process the codes to make decisions regarding starting and stopping recording.

FIG. 6 is an example of how the codes may be employed to represent modifications to a television schedule.

FIG. 7 is a system for broadcasting the codes and data fields employed to carry information.

FIG. 8 is an example of how closed-captioning may be employed to convey the codes and data fields.

### DETAILED DESCRIPTION OF THE INVENTION

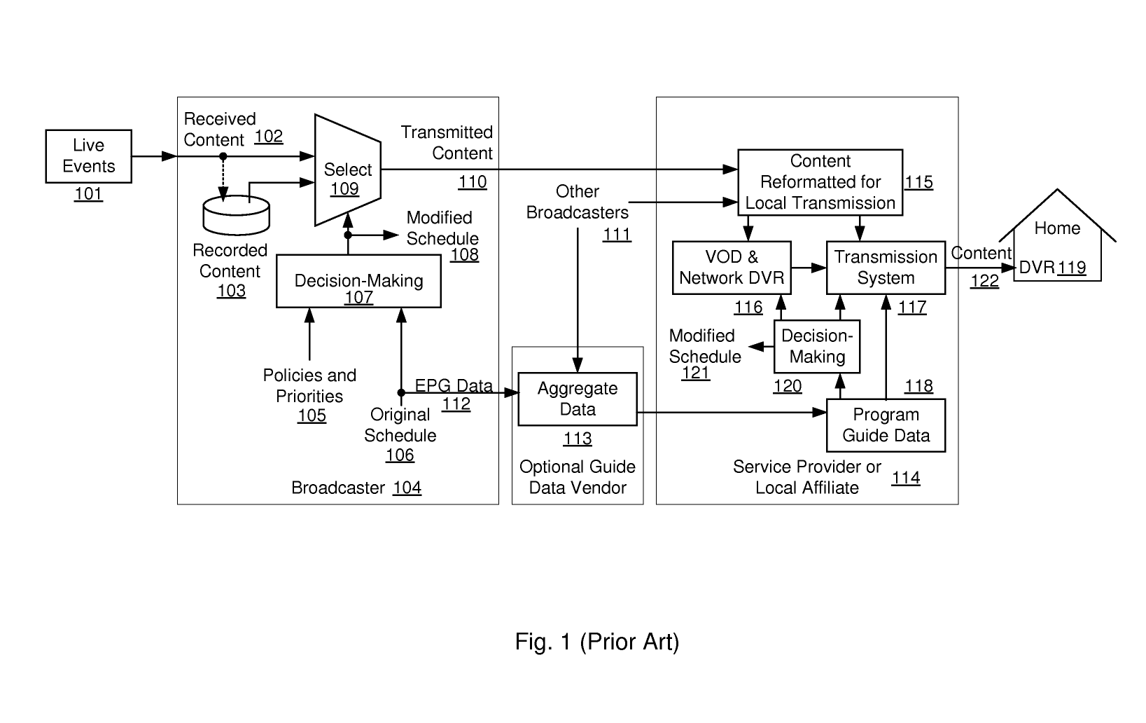

With regards to FIG. 1, a broadcaster 104 is responsible for planning and scheduling programming, and in so doing creates an original broadcast schedule 106. (As noted above, the broadcaster is the entity that controls an individual broadcast channel, such as the Golf Channel or ABC.) The programming may be in the form of a live event 101 or a pre-recorded program 103. (The live event may also be recorded and re-transmitted later.) In any case, the transmitted programming content 110 is distributed to pay TV service providers and/or local affiliates 114.

The original schedule 106 is used as part of a decision-making process 107 to determine which program to air. The broadcaster may have policies and priorities 105 it also uses. If a program runs too long, or if a program is pre-empted, a decision-making process 107 is invoked to determine what to do about it, resulting in a modified schedule 108. Usually when this happens, a program runs long and subsequent programs are delayed. There are other possibilities such as canceling or truncating subsequent programming. Note that some form of truncation or cancellation will be necessary assuming the channel runs continuously 24 hours per day.

The important point to note, and indeed a primary motivation of this invention, is that there is no clear connection between the modified schedule 108 and DVR units 119. Specifically, any unit operating off of the original schedule 106 will behave incorrectly.

The original schedule 106 is both converted to and transmitted as electronic program guide (EPG) data 112 to service providers and local affiliates 114. Often the data among multiple broadcasters 111 is aggregated by third-party guide data vendors 113, although such aggregation is optional. (These vendors may supply other services as well such as providing movie information and episode descriptions.) The aggregated program guide data 118 winds up at the service provider or local affiliate. The data is transmitted via the transmission system 117 along with television programming.

The transmission system 117 is the native transmission system used by the service provider or local affiliate. These systems are well understood in the art. A cable company typically uses a combination of fiber-optic cabling and coaxial cables (so-called hybrid fiber coax or HFC). A telephone company may use fiber-optic cabling and telephone lines, or it may use fiber directly to the home. Direct-broadcast satellite operators use geosynchronous satellites to transmit to small receiving antennas at individual homes. A local affiliate uses an antenna to send directly over-the-air to homes. (This latter case is called terrestrial broadcast to distinguish it from the direct-broadcast satellite case.)

There are several ways, well understood in the art, that the program guide data can be conveyed. The program-guide data may be transmitted on a dedicated frequency band, or it may be electronically multiplexed with the programming content. In the case of systems using MPEG transport, the data may be multiplexed by using designated PID values. The ATSC standard for terrestrial over-the-air broadcasts in the United States calls out special tables such as Event Information Tables (EITs) and Extended Text Tables (ETTs) for the purpose of carrying this data. The data may be transmitted once per day or several times per day. Often data in the near future is transmitted frequently and data in the far future less often. In some systems, the STB actively queries the program guide database on an as-needed basis. Such systems may present the EPG data to the user via a system akin to (and perhaps implemented as) web browsing. Even in these cases, in which the program guide is served in a web-browsing manner, the same issues apply—there is not a tight coupling between the broadcaster 104 and the program guide data 118.

The programming content 110 arrives along with the programming content from other broadcasters 111. Frequently this content undergoes a reformatting process 115 for transmission. For example, a service provider might charge extra for HD content, and so it reformats HD-formatted channels to SD to deliver to customers who have not paid for HD. The reformatting process 115 generally involves converting the received content to an uncompressed digital format and the recompressing it at the desired (usually lower) bitrate. Any content in the programming not directly related to audio or video may be lost in the process, as it is not carried in the uncompressed digital version of the program. However, the service providers are required by law to pass along the closed-captioning content and so this content is specifically preserved through the reformatting process 115 and passed along to the transmission system 117.

Service providers and local affiliates may record content for several reasons. First, it may offer video-on-demand services, in which subscribers request and pay for content such as movies. Second, it may perform DVR by recording the content at the headend, a system known as Network DVR. Third, it may record content so that it can be delayed and played back later. In any case, the content is recorded at the VOD and Network DVR system 116.

The local service provider and network affiliate may have the option of locally delaying a broadcast. For example, a sporting event may be of local interest. In this case, it is the local affiliate or local service provider that is exercising the option to delay the broadcast via a local decision-making process 120 which yields a locally modified schedule 121. As was the case with the modified schedule 108 there is no clear method today for transmitting the modification, and one requirement for a successful system is that it also handles this local-modification case.

The combination of live programming (e.g. programming 110 and 111) and recorded content (e.g. from the VOD and network DVR system 116) is transmitted locally via the transmission system 117. The DVRs 119 in persons' homes can then make the desired recordings by making use of the combination of programming and EPG data, transmitted as part of transmitted content 122.

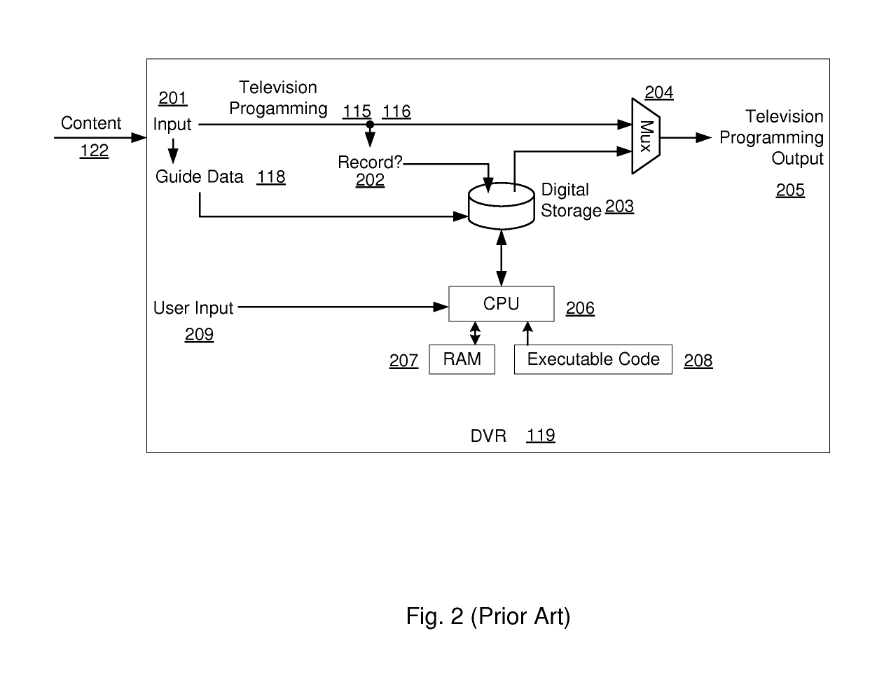

With regards to FIG. 2, the DVR 119 receives content 122 via its input 201. The input 201 is tied to the native transmission format of the service provider or local affiliate, as discussed above. The DVR may have additional inputs, not shown, such as an Internet connection. The content 122 contains a combination of live programming 115, recorded content 116, and program guide data 118, as described earlier, any part of which may be delivered over the native transmission interface or over the Internet. The DVR 119 separates the data and programming as needed. For example, it may choose to record the content (shown via recording process 202), and may optionally need to convert it to digital format. (The recording process 202 and the playback process may make use of RAM memory 207 for buffering, and there may be a direct connection from the RAM 207 and the digital storage element 203.) The digital storage element 203 is used to store the programming. The digital storage element 203 may be a hard disk drive, solid state drive, or any mechanism for storing digital data. The program guide data 118 may also be stored on the storage element 203, or possibly in RAM 207.

The CPU 206 runs executable code 208 in order to control the DVR 119. Note that the code may be software, hardware, or any combination, and the CPU may be a general-purpose microprocessor or application-specific integrated circuit (ASIC). The code may reside in ROM, PROM, EEPROM, Flash, or the digital storage element 203 and may optionally be copied into RAM 207 before being executed. The methods for designing a DVR with a CPU and executable code are well known in the art, and all combinations are considered. Generally, the code is capable of being updated in order to fix bugs and add features.

The CPU 206 (more accurately, the executable code 208 running on the CPU 206) controls the recording process 202 and controls, via mux 204, whether live or recorded content is furnished to television output 205. The Mux might be any combination of software and hardware, and the DVR may have multiple television outputs and even networked outputs.

The CPU 206 uses the guide data 118 as part of the process of controlling recordings. It also makes use of user input 209 in order to receive commands from the user (or subscriber) regarding recording preferences.

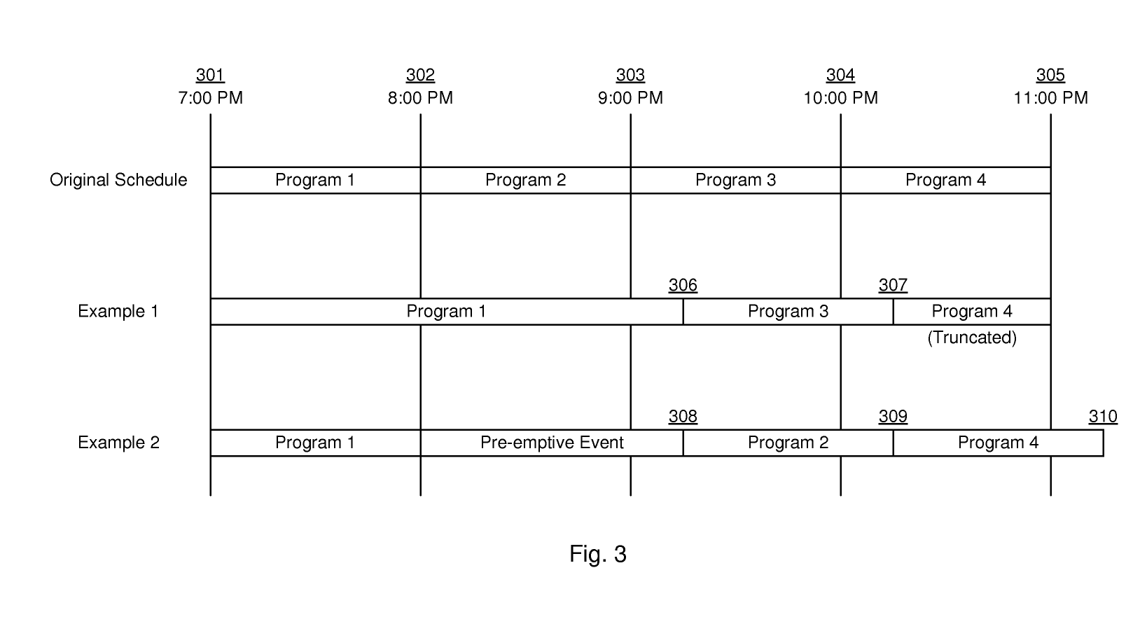

FIG. 3 illustrates a typical program schedule, and what can happen in two common cases. The original schedule calls for program 1 to air between 7:00 PM (time 301) and 8:00 PM (time 302). Program 2 is to air between 8:00 PM (time 302) and 9:00 PM (time 303), program 3 between 9:00 PM and 10:00 PM (time 304), and program 4 between 10:00 PM and 11:00 PM (time 305). Consider time 302 (8:00 PM). This is not only the scheduled start time of program 2 but it is also the schedule end time of program 1. This is a significant distinction, as in the example in which a program is pre-empted by a different event.

In Example 1,program 1 is extended by over one hour. The broadcaster elects to cancel program 2, run all of program 3 delayed by about 15 minutes, and run program 4 both delayed by about 15 minutes and truncated to its original ending time (time 305).

In Example 2, program 2 is pre-empted. This might a breaking news event, for example, or a hastily arranged Presidential address. Program 2 runs its full length but delayed by over an hour, program 3 is canceled, and program 4 runs its full length but delayed.

Without a systematic way of broadcasting changes in schedule, most DVR units would not record programs 2, 3, or 4 correctly in either example. In the case of example 2, a DVR programmed to record program 2 would in fact record the first hour of the pre-emptive event. A DVR programmed to record program 3 would record the last 15 minutes of the pre-emptive event and the first 45 minutes of program 2.

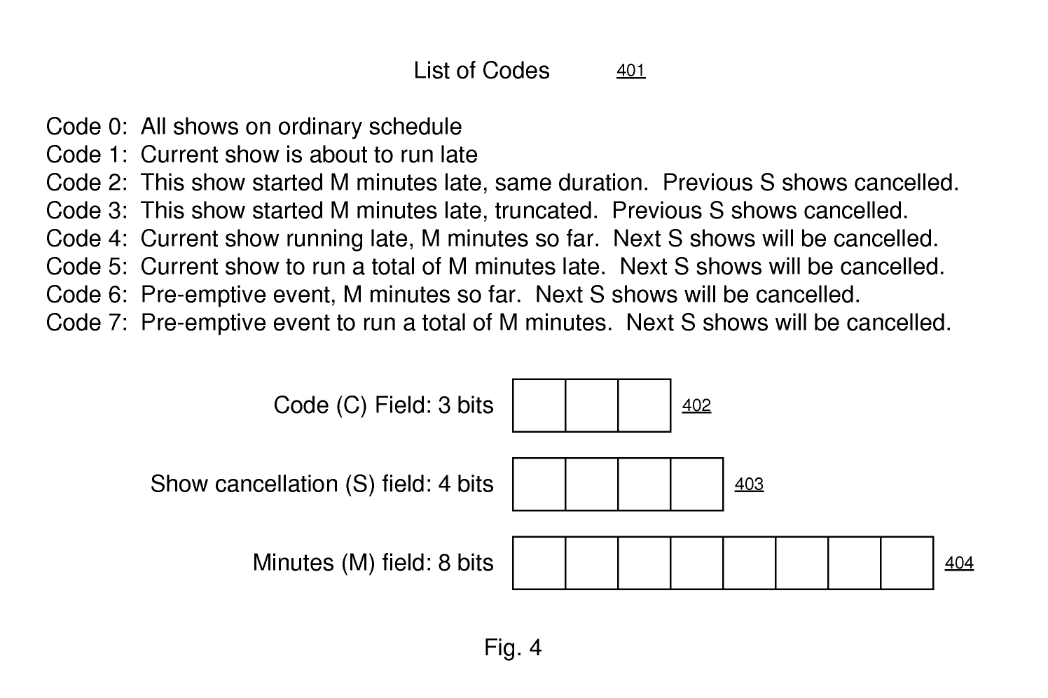

FIG. 4 presents a non-limiting example of a system of codes that can represent the current state of television programming on a channel. The purpose of the codes is to present enough information so that a DVR 119 can tune to a channel at a scheduled time to begin recording and use the codes to determine the state of the channel. These codes may be broadcast as part of the programming (e.g. in the closed-captioning data or in MPEG private sections), alongside the programming (e.g. in MPEG or ATSC data structures such as Program Map Tables or Event Information Tables), in dedicated data channels multiplexed with programming channels, or over the Internet directly to DVRs. They could even be transmitted via services such as Twitter or via SMS messaging. (The latter embodiment would be practical if the DVR were connected to a cellular network.) Codes can be broadcast at a regular schedule, such as once per minute, or more often if necessary. The codes, as will be seen, can be dynamically adjusted to reflect the current condition of the television channel's schedule.

The list of code types 401 includes eight types of codes.

Code 0 indicates that the shows are on the original broadcast schedule.

Code 1 indicates that the currently running show is about to run late. This code is necessary because it indicates that the DVR not only needs to continue recording but to check for other codes that indicate completion. Without this code, the DVR would have no reason to check for codes past the end of the originally scheduled run time. This code is able to exist because the broadcaster generally knows a show will run long before the show is completed.

Codes 2 and 3 are used during the transmission of subsequent programs. They are used to indicate the start of a delayed program and whether the program is to run its original length or will be truncated to fit inside its original time slot. An additional field indicates the number of minutes late the program started, a necessary fact to calculate the truncated run time. In addition, a DVR unit programmed to start a subsequent program (e.g. program 4 in example 1) needs to know that the program has been delayed, and the number of minutes lets the unit wait a known, calculated amount of time without having to process additional codes. An additional field indicates the number of shows that have been cancelled. This enables a DVR to determine which program is actually being transmitted.

Codes 4 and 5 are used while a program is in the process of running late. Code 4 is used when the amount of delay is not known, and Code 5 is used when the amount of delay is known (typically near the actual end of the program). Note that broadcasters typically know the amount of delay near the end so that local affiliates can remain synchronized. Both codes indicate total delay in minutes, and both codes also indicate any cancellation information. These two pieces of information permit a DVR to cancel a recording without having to monitor any more code messages, and Code 5 can be used to accurately schedule the start of a subsequent recording (since the delay is known). Note that the combination of time and cancellation is needed to determine which shows have indeed been cancelled. Codes 4 and 5 are also necessary so that a DVR that attempts to record a program understands that the program it is attempting to record has been postponed, and that a DVR that is recording a program that has run past its allotted time continues to make the recording.

Codes 6 and 7 are similar to codes 4 and 5, except they are used for pre-emptive events. Using these codes permits the previous recording to end correctly while holding off the beginning of the next recording.

Other codes may be added, and other pieces of information can be added. For example, a separate field for program duration would permit a show to be both delayed and truncated on some arbitrary time boundary. The cost of added codes and field is more data storage, more data transmission time, and greater decoding complexity, but may be considered if the value outweighs the costs.

Examples of the data field accompanying the list of code types 401 is shown. The code field 402 indicates one of eight different code types. The show cancellation field 402 indicates the number of shows that have been canceled. The minutes field 403 indicates either the amount of time the current program is running late or the amount of time a program has been delayed (depending on the context indicated by the code type).

The bit widths shown are examples. The code field 402, for example, is three bits wide to encode eight code types.

The minutes field 404 can indicated in eight bits, which is either 255 minutes if treated as an unsigned number or roughly plus or minus 128 minutes if treated as a signed number. The minutes could even be transmitted in a biased notation such as a window between minus 30 minutes and plus 225 minutes. This is a little over four hours or as many as eight 30-minute programs. Hence, in this example, the show cancellation field 403 is four bits. As with the codes, these fields can be adjusted in bit width to trade off data transmission requirements versus usability.

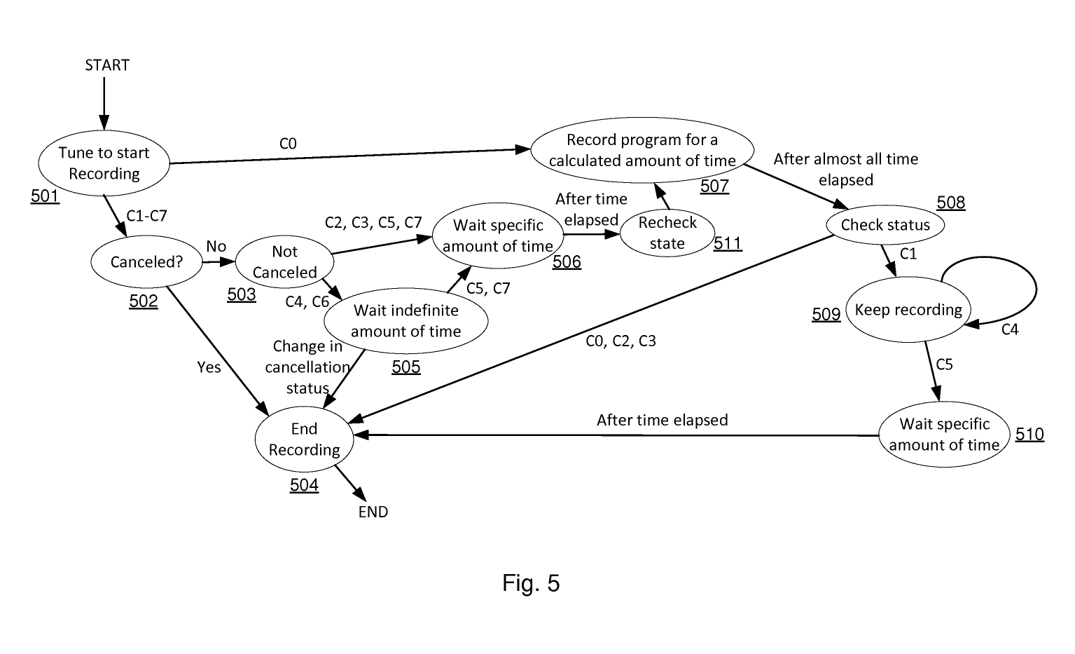

FIG. 5 shows one example embodiment of an algorithm or state machine that might be employed by a DVR 119 to process the incoming codes (the ones, for example, shown in FIG. 4) and thereby to manage the start and end of recordings. The state machine might be embodied in any combination of software and hardware, and may be incorporated into executable code 208.

One important, and possibly confusing, point is that there are two different sets of states. First, the broadcast channel is operating in a specific state at any moment in time. For example, one state of the channel may be that the current program is running long. One of the purpose of the broadcast codes 401 is to convey this state information. Second, the DVR unit 119 is operating in some state. For example, it might be waiting to start a recording or prolonging the current recording. One purpose of the state machine illustrated in FIG. 5 is to keep the state of the DVR 119 synchronized appropriately with the state of the broadcast channel.

The DVR 119 starts as indicated in FIG. 5, in state 501. (Specifically, the software task in the executable code 208 that manages recordings starts in this state.) This is the state that the DVR 119 enters when it is about to begin a scheduled recording. It does this by tuning to the scheduled channel slightly before recording starts and checking for a broadcast code, such one from the list 401.

If the DVR 119 receives code 0, which indicates the channel continues to run normally, it enters state 507 and begins recording for the scheduled amount of time. If instead it receives codes 1 through 7, it knows that the channel is in an exceptional state and enters state 502.

In state 502, the codes indicate both a time delay and cancellation of shows. By matching up the amount of delay, the number of cancelled shows (which it knows from the codes), and the number of shows scheduled to be shown during the delay period (which it knows from the program guide data), it is able to calculate whether the scheduled show has been cancelled. If it has been canceled, it enters state 504 and stops recording. If it has not been cancelled, it enters state 503.

In state 503, the behavior of the DVR 119 depends on the received codes. Codes 4 and 6 indicate that the show is delayed, but the total amount of delay is not yet known. So if these codes are received, it enters state 505 and waits until the amount of delay is known. If instead codes 2, 3, 5, or 7 are received, the amount of delay is known and it enters state 506.

In state 505, it must poll the incoming codes until a known-delay state is entered, or until new codes indicate cancellation of the show. If it is canceled, it enters state 504 and stops recording. If, instead, the amount of delay becomes known, it enters state 506.

In state 506, the amount of delay is known and so no additional polling is needed. The DVR 119 waits until the show actually begins and enters state 511.

In state 511, the show is scheduled to start. At this point additional checks are needed. For example, if the show-cancellation field was suddenly incremented, it means a decision was made to cancel a later show. The new state of the channel is indicated by the codes and fields, and so the DVR takes appropriate actions, such as possibly cancelling the recording (in a state transition not shown in the figure) or entering state 507 and beginning the recording.

In state 507, if the show is truncated (indicated by code 3), then the recording time is adjusted. It records until just before the show is scheduled to end, and enters state 508.

In state 508, it checks to see if the current show is going to be extended in time. If not (e.g. if it is receiving code 0) at the scheduled ending time, it enters state 504 and stops recording. If instead it receives code 1, it knows that the current show is going to run longer than planned and enters state 509.

Receiving code 1 before the show ends is essential because otherwise the DVR 119 has no way of knowing whether to poll for another flag when the show ends. If the DVR 119 were to receive a show-extension code after the allotted recording time, at least one problem is that it would have no way of knowing if the code applied to the current or previous program.

In state 509, the DVR polls the codes to see if the amount of delay is known or not. If not (e.g. if it receives code 4), then it must continue to record and to wait. Once the delay becomes known (e.g code 5), then it continues to record for the designated extension time and then enters state 504 and stops recording.

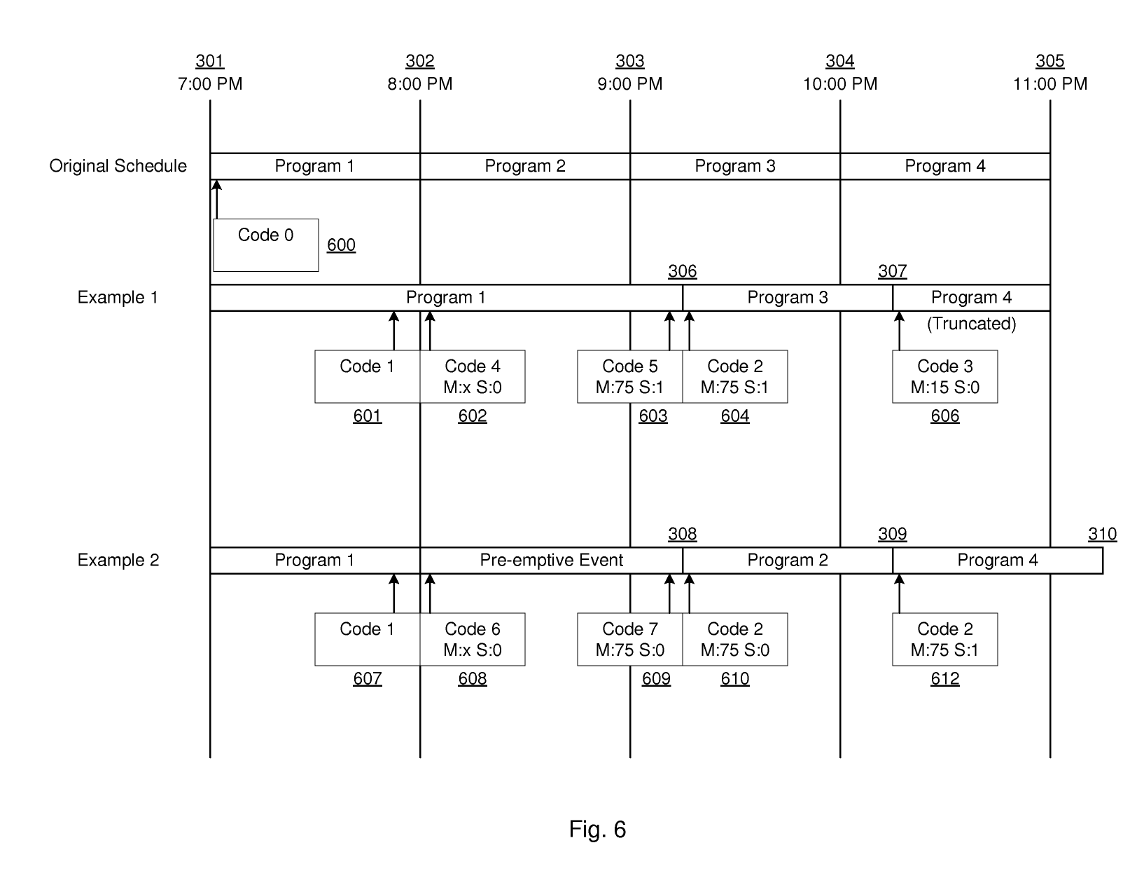

To illustrate the process by which the codes are generated and used, FIG. 3 has been reproduced in FIG. 6, but with the codes added. So FIG. 6 shows two examples of broadcast schedule changes, and with the transmitted codes that accompany the changes. In FIG. 6, the “M:” designation shows the contents of the “minutes” field. “x” represents a value that is constantly updating or changing as the code is rebroadcast (e.g. once per minute). The “S:” designation shows the contents of the show-cancellation field. For example, “M:75 S:1” means that the minutes field is 75 and the show-cancellation field is 1.

In the baseline schedule, shown at the top of FIG. 6, a broadcaster would simply transmit code 0 600 continuously. For example, the code may be rebroadcast once per minute.

In Example 1, Program 1 becomes delayed. This is normally quite clear to the broadcaster long before the actual delay period. The fact that it is about to be delayed is marked with Code 1 601 shortly before time 302, the scheduled end time of Program 1.

Once Program 1 has been delayed (that is, once the scheduled time for Program 2 to have started passes), the code switches to Code 4 602 with a “minutes” field that steadily increments. (For example, eight minutes after time 302, the “minutes” field is 8.) Code 4 indicates that the total amount of delay is not yet known, and that the channel is in a delay scenario.

Towards the end of Program 1, the broadcaster determines at what time the channel will switch over to the next program. This is the normal practice, as the broadcaster has to adjust schedule elements such as advertising slots and which programs to present or to skip. Once the broadcaster has determined that Program 2 is to be skipped and that Program 1 will run a total of 75 minutes late, the broadcaster switches from Code 4 602 to Code 5 603. Code 5 603 with “minutes” equal to 75 and show-cancellation equal to 1 indicates a total delay of 75 minutes but with 1 program to be skipped.

At time 306, Program 3 begins. At this point, the broadcast code changes to Code 2 604 with a 75-minute delay and 1 cancellation. This continues through all of Program 3.

At time 304, any DVR trying to record Program 4 will begin monitoring the channel, and any DVR recording Program 3 will have already started. At time 304, then, the channel appears to be 15 minutes late with no skipped programs. Thus when Program 3 ends and Program 4 begins, the broadcaster switches to Code 3 606 with “minutes” equal to 15 and show-cancellation equal to 0. Code 3 indicates show truncation, and so the broadcaster indicates that, even though the show started late, it will end on time.

In Example 2, a local affiliate pre-empts the normal programming with a special event. Since the pre-emptive event is known shortly before the end of Program 1, a Code 1 607 is inserted by the local affiliate at the end of Program 1. It does this by intercepting the Code 0 and replacing it with a Code 1. For the rest of the example, the local affiliate continues this practice, replacing the broadcaster's code 0 with the appropriate codes. This highlights an advantage of the invention, namely that a local affiliate may use the same system to make its own local adjustments to the broadcast schedule. For example, the pre-emptive event may be a local parade or sporting event of interest to the city.

At the beginning of the pre-emptive event, the local affiliate inserts a code 6 608 with an incrementing “minutes” field and a 0 show-cancellation field. Towards the end of the event, the affiliate inserts a Code 7 609 with a “minutes” field of 75 minutes and 0 cancellations.

Program 2 begins at time 308. At that time, the code switches to Code 2 610 with 75 minutes delay and 0 cancellations. Note that the local affiliate recorded Program 2 from the broadcaster and is now playing it back.

The affiliate cancels Program 3. So at time 309, when Program 2 ends, the state of the channel changes from 0 shows cancelled to 1 show cancelled. So the code switches to Code 2 612 with 75 minutes delay and 1 show cancellation. The use of Code 2 indicates that the program (Program 4) will run its full length.

The DVR 119 that is receiving the programming examples of FIG. 6 is able to respond to the changes as they occur, using the state machine illustrated in FIG. 5.

Consider Example 1 of FIG. 6. Program 1 begins to run late at time 302.

If the DVR 119 were scheduled to record Program 1, then it would receive code 1 before time 302 and enter state 509. The broadcaster sends code 4 while the show is running late and the total delay not yet known, keeping the DVR 119 in state 509. In this example, the broadcaster indicates 0 shows canceled. DVR 119 would keep recording until the total delay were known, shortly before time 306. This would be indicated by code 5 with a “minutes” field of 75 minutes. Also note by this time that the second program is planned to be canceled and so the show cancelation field has 1 show. Code 5 causes the DVR 119 to transition from state 509 to 510 and then, when the 75-minute extension were finished, to state 504.

If instead the DVR 119 were scheduled to record Program 2, it would tune to the channel shortly before time 302. Upon receiving code 1, it would know that the next show (that is, Program 2) would be delayed so it would enter state 502. It knows this because it is observing the channel before Program 2 started and observes a code that indicates extension of the program prior to Program 2. Once the broadcaster sends code 4 with zero show cancellations, the DVR 119 enters state 503 and then 505. As noted above, in this state it polls for more information. Once the delay exceeds the amount of time of Program 2 and once the show cancellation field is incremented to 1, the DVR 119 has enough information to determine that Program 2 has been cancelled and so it enters state 504 without ever having tried to record the show.

If instead the DVR 119 were scheduled to record Program 3, it would tune to the channel shortly before time 303. Upon receiving code 4 with zero show cancellations, the DVR 119 enters state 503 and then 505. As noted above, in this state it polls for more information. Once the delay exceeds the amount of time for Program 2 and once the show cancellation field is incremented to 1,the DVR 119 has enough information to determine that Program 2 has been cancelled. Once the broadcaster begins to transmit code 5, it knows how late Program 1 is running. It then can calculate the Program 3 will run late by an amount equal to the total delay minus the duration of the cancelled programming, in this case Program 2. At a time equal to the delayed time, the broadcaster transitions to Program 3 and code 2 (showing 15 minutes late and zero cancellations) and the DVR 119 begins recording Program 3. The fact that the broadcaster is using code 2 and not code 3 indicates that the recording time is that which was originally planned. After time 306, the channel is behaving as if it has a simple 15-minute delay, and so the show-cancellation field goes back to 0. To summarize, at time 306 the broadcaster switches to code 2 with a 15-minute delay and 0 cancellations. At time 307, which is the starting time of Program 3 plus the planned recording time, the DVR stops recording.

If instead the DVR 119 were scheduled to record Program 4, it would tune to the channel shortly before time 304. It would receive code 2 with a delay of 15 minutes and 0 cancellations. The DVR 119 then knows that the channel is running late by a known amount and ends up in state 506. It begins recording Program 4 15 minutes late in state 507. When program 4 actually starts, the broadcaster transitions to code 3, indicating truncation, with 15 minutes late and 0 cancellations. The DVR 119 then knows that the program's recording time will be shortened by an amount equal to the delay, and adjusts accordingly. At time 305, the DVR stops recording.

Consider Example 2 of FIG. 6. Program 1 runs normally and ends at time 302.

If the DVR 119 were scheduled to record Program 2, it would tune to the channel shortly before time 302 and check the status. The local affiliate sends code 1, an indication that a change in state is imminent. However, at time 302, the affiliate begins to send code 6, indicating a pre-emption. The DVR 119 then enters state 505 and polls to see the channel state. Once the length of the pre-emption is known (generally speaking, at the moment the affiliate decides to switch back to regular programming at some point in the near future), the affiliate switches to code 7 with a delay of 75 minutes and 0 cancellations. This enables the DVR 119 to calculate when Program 2 was actually going to begin, which is time 308. The DVR enters state 506 until the show actually begins, and then enters state 507. Once Program 2 begins, the affiliate switches to code 2 with 75 minutes and 0 cancellations. The DVR 119 knows that the recording time has not changed (due to the use of code 2) and so it can record the allotted time and then end recording.

If instead the DVR 119 were scheduled to record Program 3, it would tune to the channel shortly before time 303. It would receive code 6 and so enter state 505. Later it would receive code 7 and enter state 506. Code 7 with a delay of 75 minutes and 0 cancellations indicates that Program 3 will be delayed by a total of 75 minutes, so the DVR 119 can wait until time 309. At time 309, the affiliate switches to code 2 with a delay of 75 minutes and 1 show cancellation. The state of the channel at that point (that is, at time 309) is that all shows are running 75 minutes late, but 1 show was cancelled. The DVR 119, now in state 511, knows that time 309 is the start of Program 3 plus 75 minutes. But the fact that one show was canceled means that the channel has advanced one additional program, and so is showing Program 4, not Program 3. Thus Program 3 has been skipped over. The DVR 119 cancels the recording.

If instead the DVR 119 were scheduled to record Program 4, it would tune to the channel shortly before time 304. It would receive code 7 with a delay of 75 minutes and 0 cancellations, which indicates that Program 4 is scheduled to start 75 minutes late at time 310 and that the channel was broadcasting Program 2. However, knowing that cancellations are possible, the DVR 119 enters state 511 and tunes to the channel at the time of the end of Program 2, time 309. It receives Code 2 with a delay of 75 minutes and 1 cancellation. As indicated above, this is the affiliate's indication that the current program is now Program 4, but 15 minutes late, and so the DVR begins recording immediately. Code 2 indicates a normal recording time, and so the DVR records for one hour, the originally scheduled length of Program 4.

These examples illustrate but a few of the possible combinations of delays and cancellations that the system can accommodate. Also, as noted above, extensions to the codes and fields can permit a richer set of descriptions and tolerate a wider variety of last-minute schedule changes.

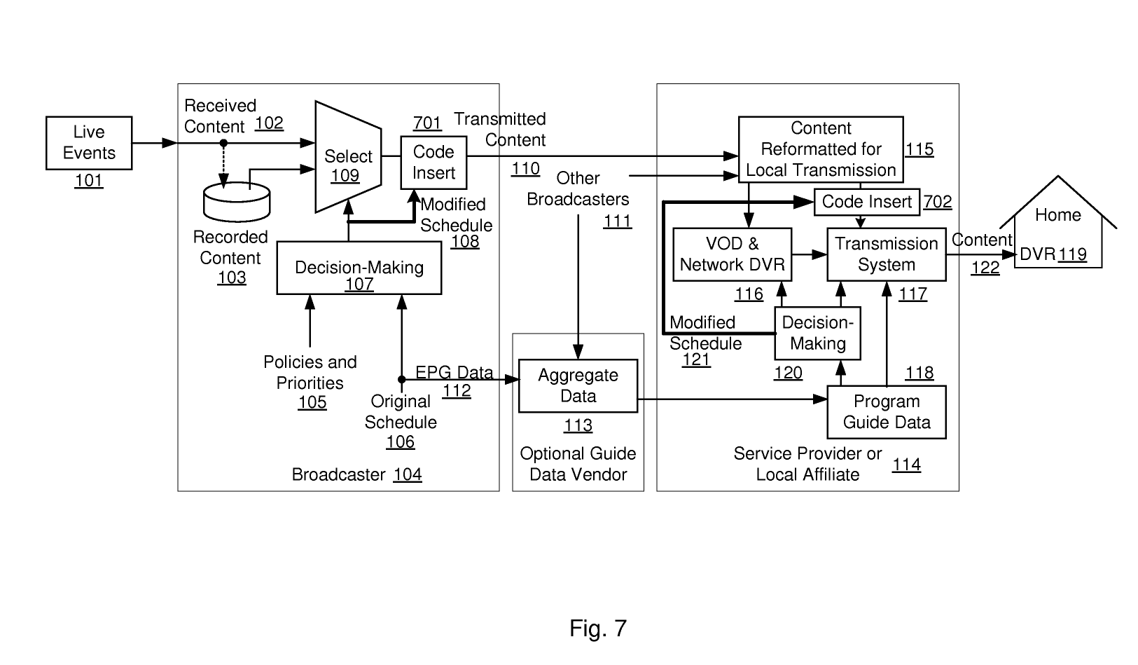

FIG. 7 illustrates the methods by which broadcasters and local affiliates may create and insert the broadcast codes. FIG. 7 is almost identical to FIG. 1, except that the modified schedule 108 and 121 are now used to feed code-insertion steps (701 and 702, respectively). Thus both broadcasters 104 and local affiliates 114 can adjust schedules as needed.

The codes and fields exemplified in FIG. 4 may be transmitted a variety of ways. For example, in digital transmissions based on the MPEG-2 and/or ATSC standards, the data may be transmitted in the picture user data. This is how closed-captioning data is transmitted in the CEA-708 standard, as is known in the art.

In another embodiment, the codes and fields may be transmitted over a separate data network directly to the DVR, such as SMS (text messages), the Internet, or Internet-related applications such as Twitter. This would have the advantages of not requiring the direct participation of the service provider, and possibly lower latency.

Closed-captioning is a method for transmitting textual data along with television programming. Described in detail in industry standard CEA-608, the method was originally designed to provide on-screen textual representations of spoken dialog for the benefit of the hearing-impaired. The system originally used the vertical blanking interval of analog television transmissions to send the data. That is, it relied on the fact that, in analog transmission, there were moments in time during which the transmitted signal was not visible on screen. The closed-captioning data was inserted into this portion of the signal, as is well known in the art.

Because of the timing involved, this enabled the transmission of two bytes of data per video field. The closed captioning system then provided for one stream on even fields and one on odd. (That is, the NTSC analog television system transmitted the even lines of video in one field and then the odd lines in the next field. Thus one full frame of video was transmitted in an interleaved manner, alternating even and odd lines.) By tying the embedded closed captioning to the two fields, it became possible to multiplex two streams of closed captioning, one for primary audio and the other for a combination of a second audio track and data.

Later, extensions were added to the CEA-608 standard such as the Extended Data Service or XDS. This enables the transmission of other forms of data in the closed-captioning system. XDS transmission is demarcated by a two-byte start and type field at the start and a two- byte end and checksum and the end, all embedded in the middle of audio captioning. In between the start and stop, pairs of bytes of data may be transmitted. The XDS system is documented in the CEA-608 standard.

Closed captioning is intended to be a part of a broadcaster's transmission, and so can be considered part of the copyrighted material of the broadcast. In addition, closed captioning enjoys special legal protection because of its role in enhancing the viewing experience of persons who are hearing-impaired. As noted above, it is treated specially and preserved through reformatting steps. Additionally, most consumer-electronic television-related devices, such as set-top boxes, television sets, and DVRs, are already designed to receive and process closed-captioning messages and fields, and so can process the codes shown in one embodiment of the current invention with little modification.

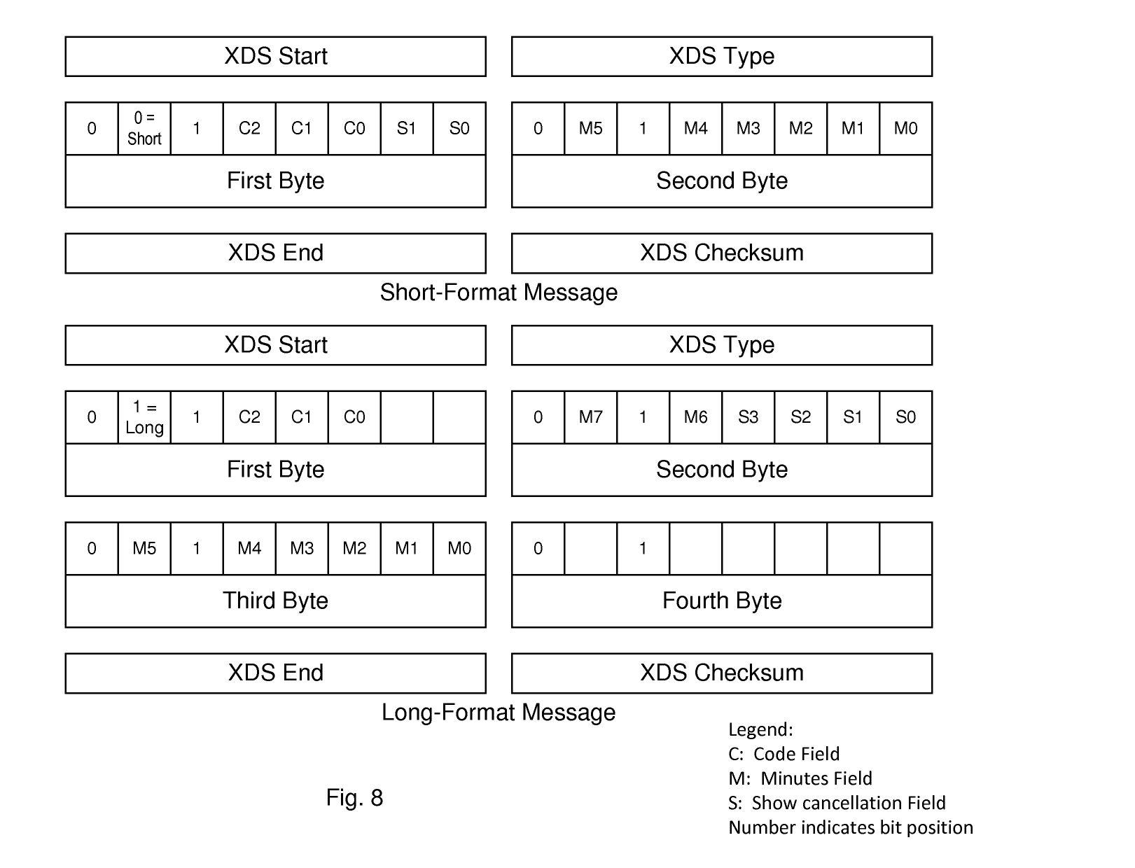

Thus closed captioning is an important example of a method by which the codes and fields can be transmitted. An embodiment of a mapping of the codes of FIG. 4 onto XDS data transmission is shown in FIG. 8. In this embodiment, there is a short format (which transmits smaller fields but in a total of two bytes) and a long format (which uses four bytes, and can accommodate all of the fields in FIG. 4 with room to spare for additional fields and data). For example, in the Short Format, there is an XDS Start byte, an XDS Type byte, two bytes of codes and fields, an XDS End byte, and an XDS Checksum. The Long Format is similar, but with four bytes of codes and fields.

The distribution of code number, the “minutes” field, and the show-cancellation field are as shown in FIG. 8. It should be noted that other embodiments are readily available, such as embodiments using more bytes to transmit a larger, more complex set of fields and codes.

The embodiments and examples described above are presented to illustrate and explain the present invention and to enable persons of ordinary skill in the art to make and use the invention. However, such persons will recognize that the embodiments and examples are for illustration and example only, and are not intended to be exhaustive or to limit the scope and spirit of the invention or of the following claims.

What is claimed is:

1. A method for transmitting information pertaining to a television broadcast, such method including the steps of:
Determining if a show is following a predetermined schedule or not;
Transmitting a first set of code or codes during the broadcast that indicate that the said predetermined schedule is being followed if the show is following the said predetermined schedule
Transmitting a second set of code or codes indicating deviation from predetermined schedule if the show is not following the said predetermined schedule.

2. The method of claim 1, wherein further
The said second set of code or codes includes at least one code indicating that the show is deviating from the normal schedule in the future.

3. The method of claim 1, wherein further
Data fields are transmitted along with the said codes, such data fields including a field indicating minutes and a field indicating number of cancelled shows.

4. The method of claim 1, wherein further
The said first set and said second set of codes are integrated into the television broadcast.

5. The method of claim 4, wherein further
The said first set and said second set of codes are transmitted in the closed-captioning data.

6. The method of claim 4, wherein further
The said first set and said second set of codes are transmitted in the picture user data.

7. The method of claim 1, wherein further
The said first set and said second set of codes are transmitted separately from the television broadcast.

8. The method of claim 1, wherein further
A service provider or local affiliate the said codes.

9. The method of claim 8, wherein further
The said step of includes removing, erasing, or eliminating at least some of the said codes.

10. An apparatus for recording shows, such apparatus including
A digital video recorder;
A receiver for receiving both codes that indicate a show is following a predetermined schedule and codes that indicate that a show is not following a predetermined schedule, such codes being transmitted during the show;
An algorithm that can use the said codes to adjust the recording schedule of the said digital video recorder;
A processor to carry out the said algorithm.

11. An apparatus for recording shows, such apparatus including
Digital video recording means;
Receiving means for receiving both codes that indicate if a show is following a predetermined schedule and codes that indicate a show is not following a predetermined schedule, such codes being transmitted during the show; and
Processing means for using the said codes to adjust the recording schedule of the said digital video recording means.
